(19) United States
(12) Patent Application Publication
(10) Pub. No.: US 2021/0343451 A1
(43) Pub. Date: Nov. 4, 2021

(54) COMMUNICATION CABLE AND WIRE HARNESS

(71) Applicant: Yazaki Corporation, Tokyo (JP)

(72) Inventor: Toshiharu Shimizu, Susono-shi (JP)

(73) Assignee: Yazaki Corporation, Tokyo (JP)

(21) Appl. No.: 17/243,910

(22) Filed: Apr. 29, 2021

(30) Foreign Application Priority Data
Apr. 30, 2020 (JP) 2020-080185

(51) Int. Cl. H01B 11/10; H01B 7/29

(52) U.S. Cl. CPC H01B 11/1016; H01B 11/1091; H01B 7/29

(57) ABSTRACT

The communication cable includes a two-core communication line including two insulated electric wires each having a conductor and an insulator covering the conductor, a drain wire and a metal foil. The two-core communication line and the drain wire are collectively covered with the metal foil. The two insulated electric wires are twisted together. The insulator has a foaming ratio being equal to or smaller than 45%. The insulator may have the foaming ratio being equal to or greater than 28%. A wire harness may include the communication cable.

### CROSS-REFERENCE TO RELATED APPLICATION

The present application claims priority to Japanese Patent Application No. 2020-080185 filed on Apr. 30, 2020, the entire content of which is incorporated herein by reference.

### TECHNICAL FIELD

The present invention relates to a communication cable and a wire harness.

### BACKGROUND

Related art communication lines for automobiles use shielded twisted pair (STP) wires that are formed by twisting electric wires together to make the communication lines flexible, since a large number of electric wire bending portions have to be formed in a small space in which a wire harness is arranged. In such STP wires, for example, a metal foil is provided around the twisted pair wires. However, since a distance between a conductor of each of the twisted pair wires and the metal foil is likely to be uneven, a large increase in an attenuation amount (so called suck-out) occurs at a specific frequency.

Therefore, in the field of consumer electronics technology, shielded parallel pair (SPP) wires are used in which a drain wire is disposed in a gap between two communication lines of a two-core communication line that are arranged in parallel and the communication lines and the drain wire are collectively covered with a metal foil (see, for example, JP2015-185527A). In the SPP wires, since the two communication lines are not twisted together, a distance between a conductor of each of the communication lines and the metal foil is likely to be stable, and a suck-out can be prevented.

However, in consumer SPP wires in the related art, since the two communication lines of the two-core communication line are not twisted together, there are a direction in which bending of the two-core communication line is easy and a direction in which bending is difficult, and in this sense, flexibility of the two-core communication line needs to be improved. However, when the two communication lines are twisted together for the purpose of improving flexibility of the two-core communication line, as mentioned earlier, the distance between a conductor of each of twist pair wires and the metal foil is likely to be uneven, which may cause a suck-out. When a suck-out frequency (i.e., a frequency at which an attenuation amount increases the most) overlaps with a frequency of a signal or the like to be transmitted, transmission characteristics of the signal or the like would greatly deteriorate.

### SUMMARY

Illustrative aspects of the present invention provide a communication cable and a wire harness configured to improve transmission characteristics and flexibility of the communication cable.

According to an illustrative aspect of the present invention, a communication cable includes a two-core communication line including two insulated electric wires each having a conductor and an insulator covering the conductor, a drain wire and a metal foil. The two-core communication line and the drain wire are collectively covered with the metal foil. The two insulated electric wires are twisted together. The insulator has a foaming ratio being equal to or smaller than 45%.

According to the configuration described above, since the two insulated electric wires of the two-core communication line are twisted together, bending in a specific direction is not difficult, and flexibility of the communication cable can be improved as compared with SPP wires. Since the insulator is provided with foams (the insulator is foamed), even when a suck-out occurs, a suck-out frequency can be increased, and it is less likely for the suck-out frequency to overlap with a frequency of a signal to be transmitted. Since a foaming ratio is reduced to 45% or less, the insulator is prevented from being crushed as in a case where the foaming ratio is greater than 45% and an impedance can be prevented from being changed greatly. Therefore, transmission characteristics of a signal to be transmitted and flexibility of the communication cable can be improved.

### BRIEF DESCRIPTION OF DRAWINGS

FIG. 1 is a perspective view showing an example of a wire harness including a communication cable according to an embodiment;

FIG. 2 is a table showing suck-out frequencies and impedances at the time of double diameter bending of communication cables in examples 1 to 7 and comparative examples 1 and 2;

FIG. 3 is a graph showing suck-out frequencies of the communication cables in the examples 2 and 7 and the comparative example 1; and

FIG. 4 is a graph showing impedances when the communication cable in the example 7 is bent.

### DESCRIPTION OF EMBODIMENTS

Hereinafter, exemplary embodiments of the present invention will be described in detail with reference to the drawings. The scope of the present invention is not limited to the exemplary embodiments described below, and it will be understood by those skilled in the art that various changes and modifications may be made therein without departing from the scope of the present invention as defined by the appended claims. In the following description of the exemplary embodiments, illustration in the drawings and detailed explanation of a part of the exemplary embodiments may be omitted. The omitted details may be supplemented by known techniques in an appropriate manner to the extent that it does not contradict the following descriptions.

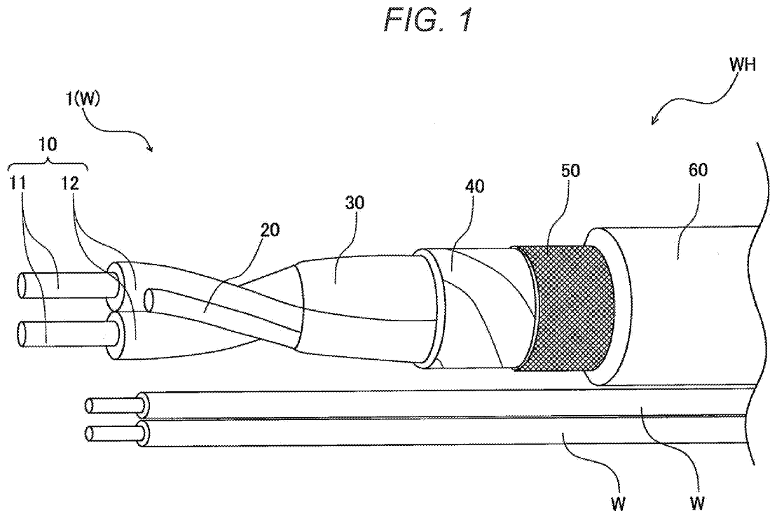

FIG. 1 is a perspective view showing an example of a wire harness including a communication cable according to an embodiment.

As shown in FIG. 1, a wire harness WH according to the present embodiment is a bundle of a plurality of electric wires W, and at least one (one circuit) of the plurality of electric wires W is provided as a communication cable 1 to be described later in detail.

The wire harness WH may include, for example, connectors (not shown) at two ends of the plurality of electric wires W, or a tape (not shown) may be wound around the wire harness WH in order to gather the communication cables 1. Alternatively, the wire harness WH may include an exterior component (not shown) such as a corrugated tube.

The communication cable 1 includes a two-core communication line 10, a drain wire 20, a metal foil 30, and a retainer 40.

The two-core communication line 10 has two insulated electric wires, each of which has a circular cross section or the like and is used for signal transmission. Each of the two insulated electric wires of the two-core communication line 10 includes a conductor 11 and an insulator 12. The insulated electric wires of two-core communication line 10 are twisted together in the present embodiment. The drain wire 20 is a noise grounding electric wire and has substantially a circular cross section. The drain wire 20 is disposed at a position between the insulated electric wires of two-core communication line 10 when the insulated electric wires of the two-core communication line 10 contact with each other while being arranged side by side with each other in a radial direction of the two-core communication line 10. The drain wire 20 is, for example, a bare electric wire having no coating in the present embodiment. The drain wire 20 is to be in a spiral shape along a longitudinal direction of the two-core communication line 10 since the insulated electric wires of the two-core communication line 10 are twisted together.

Here, the conductors 11 of the insulated electric wires of the two-core communication line 10 and the drain wire 20 are formed of a conductive member such as an annealed copper wire, a copper alloy wire, a tin-plated annealed copper wire, a tin-plated copper alloy wire, a silver-plated annealed copper wire, and a silver-plated copper alloy wire, for example. Although each of the conductors 11 and the drain wire 20 is shown as a single wire in FIG. 1, the conductors 11 and the drain wire 20 are not limited thereto, and may be a stranded wire or the like including a plurality of elemental wires.

The insulator 12 is provided on an outer periphery of the conductor 11 and covers the conductor 11. The insulator 12 is formed of a foamed insulator. Examples of the insulator 12 include foamed polyethylene (PE), polypropylene (PP), and polytetrafluoroethylene (PTFE). The insulator 12 may be provided with skin layers formed of non-foamed insulators (PE, PP, PTFE, and the like) at two sides (inner side and outer side) of a foamed layer made of, for example, foamed PE and the like.

The metal foil 30 is formed of a metal such as aluminum and copper. The metal foil 30 covers the two-core communication line 10 and the drain wire 20 together by means of longitudinal wrapping (or laterally wrapping). In the present embodiment, the metal foil 30 is integrated with a resin film (for example, a polyethylene terephthalate (PET) film) and is formed as a part of a tape having a multilayer structure. In the tape having the multilayer structure, a metal foil 30 portion formed of aluminum or copper is formed by vapor deposition or the like on a resin base material.

The retainer 40 is an insulator provided in contact with an outer peripheral side of the metal foil 30, and is formed of a resin film such as PET and PTFE or a resin extrusion coating.

Further, the communication cable 1 according to the present embodiment may include a braid 50 and a sheath 60. For example, the braid 50 may be formed of the same material as the metal foil 30. The sheath 60 is an insulator that collectively covers internal configurations of the communication cable 1, and is formed of a resin material such as polyvinyl chloride (PVC), PP, and PE.

The insulator 12 according to the present embodiment is formed of the foamed insulator as described above. The inventor of the present invention has found that a suck-out frequency can be increased by making the insulator 12 using a foamed material. Therefore, the foamed insulator 12 can be used to increase the suck-out frequency to make it difficult for the suck-out frequency to overlap with a frequency of a signal to be transmitted, so that attenuation of the signal can be prevented.

In the present embodiment, the insulator 12 has a foaming ratio (a ratio of a volume of a foamed portion to a volume of the entire insulator) of 45% or less. When the insulator 12 includes skin layers, a foaming ratio including the skin layers at two sides is 45% or less. The higher the foaming ratio is set, the higher the suck-out frequency becomes. Meanwhile, the smaller the foaming ratio is set, the larger a crushed remainder ratio when a predetermined load is applied for the predetermined period of time becomes, and it becomes easier to prevent occurrence of changes in impedance. Therefore, when the foaming ratio is set to 45% or less, a change amount of the impedance can be limited to about 5% or less, and characteristics can be stabilized.

The crushed remainder ratio is a value obtained in a manner as described below. A communication line is interposed between two plates, and a load of 1 kg is applied from one plate toward the other plate for 30 minutes. Here, the plates are, for example, steel plates that are fairly hard compared with the insulator and the plates are substantially not deformed at the time of deformation of the insulator by applying the load. The crushed remainder ratio is a value obtained by dividing a diameter of the communication line after applying the load by a diameter of the communication line before applying the load.

In the present embodiment, a foaming ratio of the insulator 12 is preferably 28% or more. Accordingly, a suck-out frequency of, for example, 5.08 GHz can be increased to 5.4 GHz or more. The foaming ratio of the insulator 12 is more preferably 30% or more, and even more preferably 41% or more. In these cases, a suck-out frequency of, for example, 5.08 GHz can be increased to 5.5 GHz or more or to 5.7 GHz or more.

The communication cable 1 according to the present embodiment is manufactured as follows. First, the two-core communication line 10 and the drain wire 20 are arranged in parallel, the metal foil 30 is wound on the two-core communication line 10 and the drain wire 20, and the retainer 40 is provided thereon. Thereafter, the insulated electric wires of the two-core communication line 10 are twisted together with the metal foil 30 and the retainer 40 to have a predetermined twist pitch, and then the braid 50 and the sheath 60 are provided thereon. In this manner, the communication cable 1 is manufactured. The retainer 40 may be provided by extrusion coating after the insulated electric wires of the two-core communication line 10 are twisted.

Next, examples and comparative examples of the communication cable 1 according to the present embodiment will be described. First, for communication cables in examples 1 to 7 and comparative examples 1 and 2, two-core communication lines, drain wires, metal foils, retainers, braids, and sheaths were all the same. As conductors of the two-core communication lines and the drain wire, a tin-plated annealed copper wire was used. The metal foil was formed of aluminum, and was formed as a part of a tape having a multilayer structure employing vapor deposition on a PET base material. As the retainer, a PET film was used.

For the communication cables in the examples 1 to 7 and the comparative examples 1 and 2, a twist pitch of the insulated electric wires of the two-core communication line was 19 to 21 mm, and the metal foil was laterally wound (without an end portion folded) on the two-core communication lines and the drain wire. The braid used a braid obtained by braiding tin-plated annealed copper wires. The sheath was formed by extrusion-molding PVC on the braid.

For the communication cables in the examples 1 to 7 and the comparative examples 1 and 2, the insulators in the examples 1 to 7 and the comparative example 2 had a three-layer structure in which a foamed layer (foamed PE) was interposed between skin layers (non-foamed PE) such that both an inner side and an outer side of the foamed layer contact the skin layers. The insulator in the comparative example 1 had a non-foamed one-layer structure (non-foamed PE). Foaming ratios of foamed layers in the examples 1 to 7 and the comparative example 2 were respectively set to 10%, 28%, 30%, 32%, 41%, 43%, 45%, and 50%.

For the communication cables in the examples 1 to 7 and the comparative examples 1 and 2 as described above, suck-out frequencies were measured, and impedances (Ω) at the time of double diameter bending of the communication cables were measured. The double diameter bending corresponds to bending of the communication cable when the communication cable is wound around a cylindrical member having a diameter being twice a diameter of the communication cable.

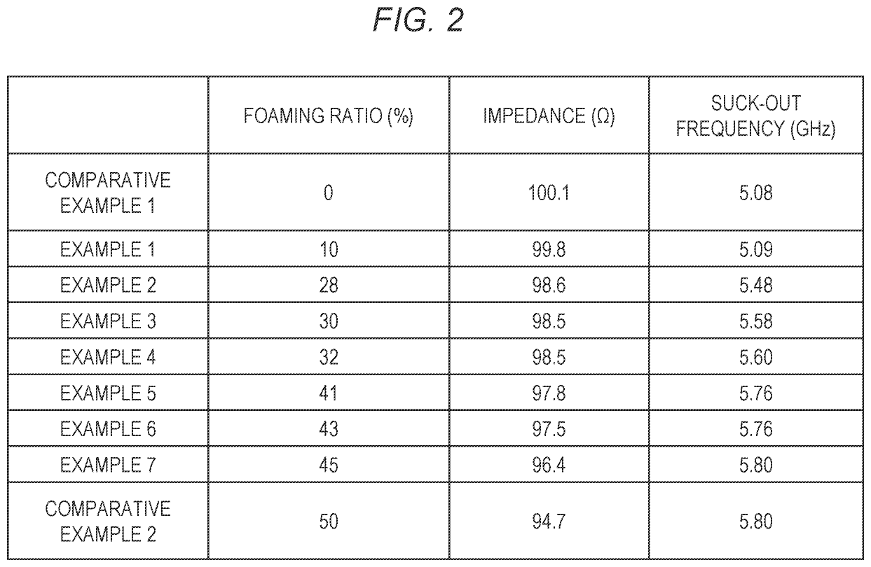

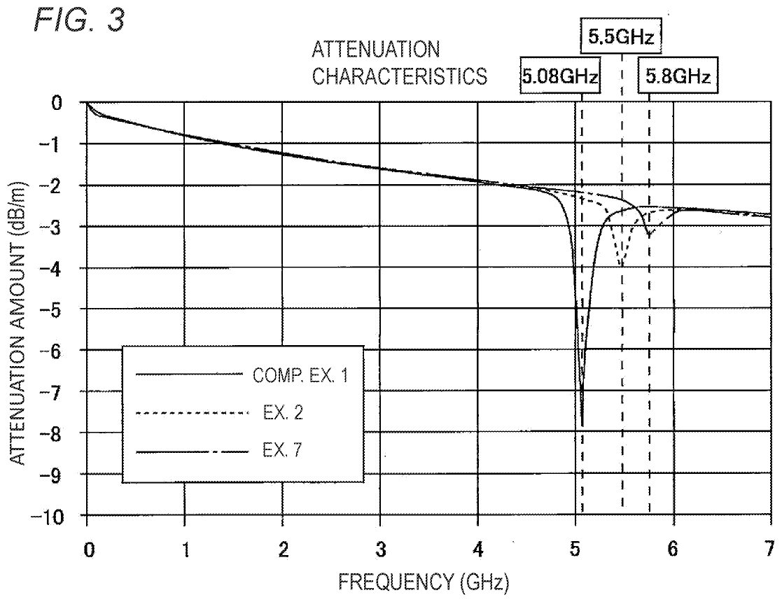

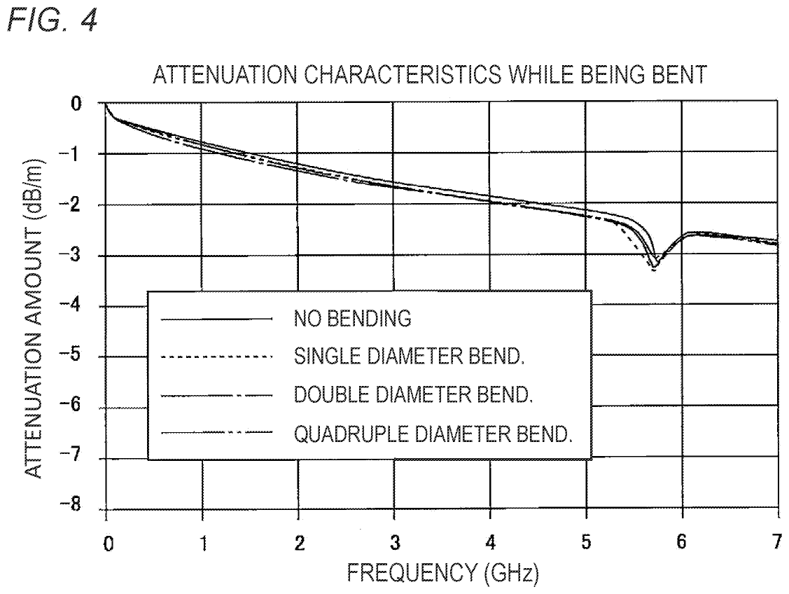

FIG. 2 is a table showing suck-out frequencies and impedances at the time of double diameter bending of the communication cables in the examples 1 to 7 and the comparative examples 1 and 2. FIG. 3 is a graph showing suck-out frequencies of the communication cables in the examples 2 and 7 and the comparative example 1. FIG. 4 is a graph showing impedances when the communication cable in the example 7 is bent.

As shown in FIGS. 2 and 3, suck-out frequencies of the communication cables in the examples 1 to 7 were respectively 5.09 GHz, 5.48 GHz, 5.58 GHz, 5.60 GHz, 5.76 GHz, 5.76 GHz, and 5.80 GHz. A suck-out frequency of the communication cable in the comparative example 1 was 5.08 GHz, and a suck-out frequency of the communication cable in the comparative example 2 was 5.80 GHz.

Therefore, it was found that the higher the foaming ratio of the insulator is set, the higher the suck-out frequency becomes. Therefore, the foaming ratio of the insulator is preferably set to be high for the purpose of increasing the suck-out frequency.

Although incidentally, it was found that a suck-out is prevented as the foaming ratio of the insulator becomes higher, as shown in FIG. 3.

As shown in FIG. 2, at the time of double diameter bending is performed on the communication cables, impedances of the communication cables in the examples 1 to 7 were respectively 99.8Ω, 98.6Ω, 98.5Ω, 98.5Ω, 97.8Ω, 97.5Ω, and 96.4Ω. An impedance of the communication cable in the comparative example 1 was 100.1Ω, and an impedance of the communication cable in the comparative example 2 was 94.7Ω.

Therefore, it was found that the impedance becomes increasingly unstable as the foaming ratio increases. This is because volume of empty space in the insulator increases when the foaming ratio increases, and thus the insulator is easily deformed.

As shown in FIG. 4, for the communication cable in the example 7, an attenuation amount is smallest when there is no bending. The attenuation amount is larger in order of single diameter bending, double diameter bending, quadruple diameter bending and no bending. The quadruple diameter bending corresponds to bending of the communication cable when the communication cable is wound around a cylindrical member having a diameter being four times a diameter of the communication cable and the single diameter bending corresponds to bending of the communication cable when the communication cable is wound around a cylindrical member having the same diameter as the communication cable. Therefore, it was found that the impedance of the communication cable basically tends to become larger as the communication cable is bent tighter.

The communication cable in the example 1 had a crushed remainder ratio of 99% or more, the communication cables in the examples 2 to 4 had a crushed remainder ratio of 98% or more and 99% or less, and the communication cables in the examples 5 to 7 had a crushed remainder ratio of 96% or more and 98% or less. Therefore, it was found that based on a crushed remainder ratio, it is preferable to have a foaming ratio at which the crushed remainder ratio is 96% or more and 98% or less.

In this manner, according to the communication cable 1 and the wire harness WH in the present embodiment, since the insulated electric wires of the two-core communication line 10 are twisted together, bending in a specific direction is not difficult, and flexibility can be improved compared with SPP wires. Since the insulator 12 is foamed, even when a suck-out occurs, a suck-out frequency can be increased, and it is less likely for the suck-out frequency to overlap with a frequency of a signal to be transmitted. Since a foaming ratio is reduced to 45% or less, the insulator 12 is prevented from being crushed as in a case where the foaming ratio is larger than 45% and an impedance can be prevented from being changed greatly. As a result, transmission characteristics and flexibility of the communication cable can be improved.

Since the insulator 12 has a foaming ratio of 28% or more, a suck-out frequency of, for example, 5.08 GHz can be increased to 5.4 GHz or more.

While the present invention has been described with reference to certain exemplary embodiments thereof, the scope of the present invention is not limited to the exemplary embodiments described above, and it will be understood by those skilled in the art that various changes and modifications may be made therein without departing from the scope of the present invention as defined by the appended claims.

For example, a twist pitch of the insulated electric wires of the two-core communication lines is 19 mm or more and 21 mm or less in the examples. The present invention is not limited to the examples described above.

What is claimed is:

1. A communication cable comprising:
a two-core communication line including two insulated electric wires each having a conductor and an insulator covering the conductor;
a drain wire; and
a metal foil,
wherein the two-core communication line and the drain wire are collectively covered with the metal foil,
wherein the two insulated electric wires are twisted together, and
wherein the insulator has a foaming ratio being equal to or smaller than 45%.

2. The communication cable according to claim 1,
wherein the insulator has the foaming ratio being equal to or greater than 28%.

3. A wire harness comprising:
the communication cable according to claim 1.
